(19) United States
(12) Patent Application Publication
(10) Pub. No.: US 2026/0357097 A1
(43) Pub. Date: Nov. 12, 2026

(54) PRE-TREATMENT LIQUID AND INK SET

(71) Applicant: KYOCERA DOCUMENT SOLUTIONS INC., OSAKA-SHI (JP)

(72) Inventor: AI SANDA, OSAKA-SHI (JP)

(21) Appl. No.: 19/668,829

(22) Filed: May 6, 2026

(30) Foreign Application Priority Data
May 12, 2025 (JP) 2025-080123

(51) Int. Cl. C09D 11/54; C09D 11/38; C09D 11/40

(52) U.S. Cl. CPC C09D 11/54; C09D 11/38; C09D 11/40

(57) ABSTRACT

A pre-treatment liquid is used for pre-treatment of a recording medium on which an image is recorded with a water-based ink. The pre-treatment liquid includes: 6 mass % or more and 12 mass % or less of calcium acetate; 20 mass % or more and 30 mass % or less of urea; 20 mass % or more of a first water-soluble organic solvent; and water. In the pre-treatment liquid, a total content of the urea and the water-soluble organic solvent is 50 mass % or less.

### CROSS-REFERENCE TO RELATED PATENT APPLICATION

This application claims the benefit of Japanese Priority Patent Application JP 2025-080123 filed on May 12, 2025, the entire contents of which are incorporated herein by reference.

### FIELD OF THE DISCLOSURE

The present disclosure relates to a pre-treatment liquid and an ink set.

### BACKGROUND OF THE DISCLOSURE

There is known a technology for performing pre-treatment on a recording medium with a pre-treatment liquid before forming an image with a water-based ink in order to form a high-quality image with high density while suppressing image defects such as color unevenness and image cracking. As the pre-treatment liquid, one that allows an image with sufficiently high density to be formed with a small amount of water-based ink by the action of a metal salt that makes pigments more likely to agglomerate on the surface of the recording medium has been known.

### SUMMARY OF THE DISCLOSURE

A pre-treatment liquid according to an embodiment of the present disclosure is used for pre-treatment of a recording medium on which an image is recorded with a water-based ink.

The pre-treatment liquid includes: 6 mass % or more and 12 mass % or less of calcium acetate; 20 mass % or more and 30 mass % or less of urea; 20 mass % or more of a first water-soluble organic solvent; a first surfactant; and water.

In the pre-treatment liquid, a total content of the urea and the first water-soluble organic solvent is 50 mass % or less.

An ink set according to an embodiment of the present disclosure includes: the pre-treatment liquid; and a water-based ink.

The water-based ink includes a pigment, a pigment dispersion resin, a second water-soluble organic solvent, a second surfactant, and water.

### DETAILED DESCRIPTION OF THE EXEMPLARY EMBODIMENTS

In the above technology, the action of a metal salt that makes pigments more likely to agglomerate tends to reduce the area per dot formed on the recording medium by a single droplet of ink ejected from the recording head. This makes it easier for gaps to occur in the image formed on the recording medium. In this regard, increasing the ejection amount of the water-based ink allows the occurrence of gaps in the image to be suppressed.

However, increasing the ejection amount of the water-based ink tends to cause deeper penetration in the thickness direction of the recording medium, making a phenomenon called “bleed-through” where the image formed on the recording medium becomes visible from the back side more likely to occur. When the bleed-through of water-based ink occurs, during double-sided printing on a recording medium, the image formed on the front side and the image formed on the back side interfere with each other, reducing the visibility of both images.

In view of the circumstances as described above, it is an object of the present disclosure to provide a pre-treatment liquid for a recording medium that is capable of simultaneously suppressing the occurrence of bleed-through of water-based ink and gaps in images.

An embodiment of the present disclosure will be described.

### [Configuration of Ink Set]

An ink set according to an embodiment of the present disclosure includes a pre-treatment liquid and a water-based ink (hereinafter, also referred to simply as an “ink”). A recording medium on which an image is to be formed with the ink set according to this embodiment is a recording medium formed of a fiber such as a cellulose fiber, typically, thin paper. The ink set according to this embodiment tends to provide more advantages when the basis weight of a recording medium on which an image is to be formed is 60 gsm or more and 70 gsm or less.

In the ink set according to this embodiment, the pre-treatment liquid is applied onto the recording surface of the recording medium and then an image is formed with the ink. In the ink set according to this embodiment, by using a pre-treatment liquid that includes a specific component, it is possible to selectively promote the wettability of the ink impacted on the recording medium in the in-plane direction while suppressing the permeability of the ink in the thickness direction, thereby simultaneously suppressing the occurrence of bleed-through of ink and gaps in images.

The above effects of the pre-treatment liquid according to this embodiment are more effectively achieved in combination with the ink in the ink set according to this embodiment. However, the above effects of the pre-treatment liquid according to this embodiment are also effectively achieved in combination with water-based inks different from the ink set according to this embodiment instead of being used as the ink set according to this embodiment. That is, the pre-treatment liquid according to this embodiment is also useful as a standalone product.

### [Pre-Treatment Liquid]

### (Schematic Configuration)

The pre-treatment liquid constituting the ink set according to this embodiment includes calcium acetate, urea, a first water-soluble organic solvent, a first surfactant, and water. Respective components of the pre-treatment liquid according to this embodiment will be described below.

### (Calcium Acetate)

In the pre-treatment liquid according to this embodiment, calcium acetate is blended as a metal salt. In the pre-treatment liquid according to this embodiment, the action of calcium acetate that is a metal salt having high water-solubility, which strongly promotes agglomeration of pigments, allows penetration of the ink in the thickness direction on the recording medium to be suppressed. As a result, in the pre-treatment liquid according to this embodiment, it is possible to suppress the occurrence of bleed-through of ink on the recording medium.

In the pre-treatment liquid according to this embodiment, the content of calcium acetate is 6 mass % or more and 12 mass % or less. In the pre-treatment liquid according to this embodiment, by setting the content of calcium acetate to 6 mass % or more, the effect of suppressing bleed-through of ink on the recording medium can be achieved. In the pre-treatment liquid according to this embodiment, by setting the content of calcium acetate to 12 mass % or less, the effect of hindering ink wet-spreading on a recording medium in the in-plane direction can be kept small.

### (Urea)

In the pre-treatment liquid according to this embodiment, urea is blended as a moisturizing agent. In the pre-treatment liquid according to this embodiment, the high moisturizing effect of urea enhances the wettability of ink in the in-plane direction on a recording medium, ensuring the area per dot formed on the recording medium by a single droplet of ink. As a result, in the pre-treatment liquid according to this embodiment, it is possible to suppress the occurrence of gaps in the image formed on the recording medium with the ink.

In the pre-treatment liquid according to this embodiment, the content of urea is 20 mass % or more and 30 mass % or less. In the pre-treatment liquid according to this embodiment, by setting the content of urea to 20 mass % or more, the occurrence of gaps in the image formed on the recording medium with the ink is more likely to be suppressed. In the pre-treatment liquid according to this embodiment, by setting the content of urea to 30 mass % or less, the effect of suppressing bleed-through of ink by calcium acetate is less likely to be impaired.

### (First Water-Soluble Organic Solvent)

In the pre-treatment liquid according to this embodiment, the first water-soluble organic solvent is not limited to a specific type as long as it has compatibility with other components.

Examples of the first water-soluble organic solvent that can be used for the pre-treatment liquid according to this embodiment include glycerin, triethylene glycol, dipropylene glycol monopropyl ether, diethylene glycol, triethylene glycol monomethyl ether, ethylene glycol, propylene glycol monobutyl ether, tripropylene glycol monomethyl ether, diethylene glycol butyl methyl ether, diethylene glycol monomethyl ether, 1,3-propanediol, propylene glycol, propylene glycol monopropyl ether, ethylene glycol monomethyl ether, propylene glycol monoisopropyl ether, diethylene glycol monoethyl ether, ethylene glycol monomethyl ether, monoethyl ether, diethylene glycol monopropyl ether, 2-propanol, dimethyl ether, 1-propanol, diethylene glycol diethyl ether, triethylene glycol monobutyl ether, and 3-methyl-1,5-pentanediol.

In the pre-treatment liquid according to this embodiment, the content of the first water-soluble organic solvent is 20 mass % or more in order to effectively achieve the effect of enhancing the wettability of ink in the in-plane direction on the recording medium by urea. Further, in the pre-treatment liquid according to this embodiment, the total content of urea and the first water-soluble organic solvent is 50 mass % or less in order to effectively achieve the effect of suppressing bleed-through of ink on the recording medium.

### (First Surfactant)

In the pre-treatment liquid according to this embodiment, the first surfactant is not limited to a specific type. In the pre-treatment liquid according to this embodiment, a nonionic surfactant is favorably used as the first surfactant.

Examples of the nonionic surfactant that can be used for the pre-treatment liquid according to this embodiment include a nonionic acrylic resin or its prepolymer. It is favorable that the nonionic acrylic resin is water-soluble and is, for example, a copolymer of a hydrophilic monomer and a hydrophobic monomer. The hydrophilic monomer is favorably, for example, polyethylene glycol acrylate (PEGA), methyl methacrylate (MMA), methyl acrylate (MA), ethyl acrylate (EA), or ethyl methacrylate (EMA). The hydrophobic monomer is favorably, for example, n-butyl acrylate (BA), polypropylene glycol acrylate (PPGA), lauryl acrylate (LA), stearyl acrylate (SA), benzyl acrylate, or benzyl methacrylate.

The nonionic surfactant may be an acetylene glycol surfactant. Examples of the commercially available acetylene glycol surfactant include “OLFINE E1010,” “SURFYNOL 104,” “SURFYNOL 420,” “SURFYNOL 440,” and “KL-870” manufactured by Nissin Chemical Co., Ltd.

In the pre-treatment liquid according to this embodiment, the content of the first surfactant is favorably 0.05 mass % or more and 1 mass % or less.

### (Water)

In the pre-treatment liquid according to this embodiment, ion exchanged water, purified water, distilled water, or the like can be used as water. In the pre-treatment liquid according to this embodiment, the content of water is favorably 40 mass % or more and 80 mass % or less from the viewpoints of dryness and ejection reliability.

### (Other Components)

In the pre-treatment liquid according to this embodiment, a component other than the above may be blended as necessary. For example, in the pre-treatment liquid according to this embodiment, various additives such as a dissolution stabilizer, an anti-drying agent, an antioxidant, a viscosity adjustor, a pH adjuster, and an antifungal agent may be blended as necessary.

### [Water-Based Ink]

### (Schematic Configuration)

The water-based ink constituting the ink set according to this embodiment includes a pigment, a pigment dispersion resin, a second water-soluble organic solvent, a second surfactant, and water. The ink according to this embodiment is configured such that when used together with the above pre-treatment liquid, the occurrence of bleed-through in a recording medium and gaps in the image formed on the recording medium are more likely to be suppressed simultaneously. Respective components of the ink according to this embodiment will be described below.

### (Pigment)

In the ink according to this embodiment, the pigment may be either an inorganic pigment or an organic pigment. Further, as the pigment, these may be combined with an extender pigment, as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. In the ink according to this embodiment, one or more selected from these colored pigments may be used as the pigment.

In the ink according to this embodiment, the content of the pigment is favorably 6 mass % or more and 10 mass % or less.

### (Pigment Dispersion Resin)

In the ink according to this embodiment, a pigment dispersion resin for enhancing the dispersibility of the pigment in the solvent is blended. The pigment dispersion resin is fine particles of a resin and suppresses agglomeration of pigments by being adsorbed on the surface of the pigment. In the ink in which the pigment dispersion resin is blended, the pigment and the pigment dispersion resin integrally form a pigment dispersion. The pigment dispersion includes, for example, a core that includes a pigment and a pigment dispersion resin that coats the core. Part of the pigment dispersion resin may be dispersed in the solvent without being adsorbed on the surface of the pigment.

As the pigment dispersion resin, a known pigment dispersion resin can be appropriately selected and used. Specific examples of the pigment dispersion resin include a styrene-acrylic resin, a styrene-maleic acid copolymer, a styrene-maleic acid half ester copolymer, a vinylnaphthalene-acrylic acid copolymer, and a vinyl naphthalene-maleic acid copolymer. The styrene-acrylic resin is a resin including a unit derived from styrene and a unit derived from acrylic acid, methacrylic acid, acrylic acid ester, or methacrylic acid ester. Examples of the styrene-acrylic resin include a styrene-acrylic acid-acrylic acid alkyl ester copolymer, a styrene-methacrylic acid-methacrylic acid alkyl ester-acrylic acid alkyl ester copolymer, a styrene-acrylic acid copolymer, a styrene-maleic acid-acrylic acid alkyl ester copolymer, a styrene-methacrylic acid copolymer, and a styrene-methacrylic acid alkyl ester copolymer. Of these pigment dispersion resins, a styrene-acrylic resin is favorable, a styrene-methacrylic acid-methacrylic acid alkyl ester-acrylic acid alkyl ester copolymer is more favorable, and a styrene-methacrylic acid-methyl methacrylate-butyl acrylate copolymer is particularly favorable because they are easily prepared and have an excellent effect of dispersing the pigment.

In the ink according to this embodiment, the content of the pigment dispersion resin is favorably 0.5 mass % or more and 8.0 mass % or less. In the ink according to this embodiment, by setting the content of the pigment dispersion resin to 0.5 mass % or more, it is possible to suppress agglomeration of pigments more effectively. In the ink according to this embodiment, by setting the content of the pigment dispersion resin to 8.0 mass % or less, it is possible to suppress the occurrence of ejection failure.

### (Second Water-Soluble Organic Solvent)

In the ink according to this embodiment, the second water-soluble organic solvent is not limited to a specific type as long as it has compatibility with other components. In the ink set according to this embodiment, the second water-soluble organic solvent constituting the ink may be a water-soluble organic solvent common to that of the first water-soluble organic solvent constituting the pre-treatment liquid or a water-soluble organic solvent different from that of the first water-soluble organic solvent constituting the pre-treatment liquid.

Examples of the second water-soluble organic solvent that can be used for the ink according to this embodiment include glycerin, triethylene glycol, dipropylene glycol monopropyl ether, diethylene glycol, triethylene glycol monomethyl ether, ethylene glycol, propylene glycol monobutyl ether, tripropylene glycol monomethyl ether, diethylene glycol butyl methyl ether, diethylene glycol monomethyl ether, 1,3-propanediol, propylene glycol, propylene glycol monopropyl ether, ethylene glycol monomethyl ether, propylene glycol monoisopropyl ether, diethylene glycol monoethyl ether, ethylene glycol monomethyl ether, monoethyl ether, diethylene glycol monopropyl ether, 2-propanol, dimethyl ether, 1-propanol, diethylene glycol diethyl ether, triethylene glycol monobutyl ether, and 3-methyl-1,5-pentanediol.

In the ink according to this embodiment, the content of the second water-soluble organic solvent is favorably 10 mass % or more and 50 mass % or less.

### (Second Surfactant)

In the ink according to this embodiment, the second surfactant is not limited to a specific type. In the ink according to this embodiment, a nonionic surfactant is favorably used as the second surfactant. In the ink set according to this embodiment, the second surfactant constituting the ink may be a surfactant common to that of the first surfactant constituting the pre-treatment liquid or a surfactant different from the first surfactant constituting the pre-treatment liquid.

Examples of the nonionic surfactant that can be used for the ink according to this embodiment include a nonionic acrylic resin or its prepolymer. It is favorable that the nonionic acrylic resin is water-soluble and is, for example, a copolymer of a hydrophilic monomer and a hydrophobic monomer. The hydrophilic monomer is favorably, for example, polyethylene glycol acrylate (PEGA), methyl methacrylate (MMA), methyl acrylate (MA), ethyl acrylate (EA), or ethyl methacrylate (EMA). The hydrophobic monomer is favorably, for example, n-butyl acrylate (BA), polypropylene glycol acrylate (PPGA), lauryl acrylate (LA), stearyl acrylate (SA), benzyl acrylate, or benzyl methacrylate.

The nonionic surfactant may be an acetylene glycol surfactant. Examples of the commercially available acetylene glycol surfactant include “OLFINE E1010,” “SURFYNOL 104,” “SURFYNOL 420,” “SURFYNOL 440,” and “KL-870” manufactured by Nissin Chemical Co., Ltd.

In the ink according to this embodiment, the content of the second surfactant is favorably 0.05 mass % or more and 1 mass % or less.

### (Water)

In the ink according to this embodiment, ion exchanged water, purified water, distilled water, or the like can be used as water. In the ink according to this embodiment, the content of water is favorably 40 mass % or more and 80 mass % or less from the viewpoints of dryness and ejection reliability.

### (Other Components)

In the ink according to this embodiment, components other than the above may be blended as necessary. For example, in the ink according to this embodiment, various additives such as a dissolution stabilizer, an antioxidant, a viscosity adjustor, a pH adjuster, and a neutralizer may be blended as necessary.

### Examples and Comparative Examples

As Examples and Comparative Examples of the present disclosure, preparation of a pre-treatment liquid and an ink, and evaluation of the pre-treatment liquid were performed. Note that the following Examples are merely illustrative examples of the present disclosure, and the present disclosure is not limited to the configurations of the following Examples.

### (Preparation of Pre-Treatment Liquid)

In Examples and Comparative Examples, pre-treatment liquids having different configurations were prepared. All of the pre-treatment liquids according to Examples and Comparative Examples were prepared by stirring predetermined components with a stirrer. In the pre-treatment liquids according to Examples and Comparative Examples, the types and amounts of components to be blended were varied.

(Preparation of ink)

Inks having common configurations were prepared for Examples and Comparative Example. First, a pigment dispersion liquid in which a pigment was dispersed in water was prepared. The pigment dispersion liquid was prepared by blending a pigment, a pigment dispersion resin, sodium hydroxide, OLFINE (registered trademark) E1010, and water such that the content shown in Table 1 was achieved.

TABLE 1

| Pigment dispersion liquid | Content (mass %) |
|---|---|
| Pigment | 15 |
| Pigment dispersion resin | 6 |
| NaOH | 0~0.1 |
| OLFINE E1010 | 0.5 |
| Water | Remainder |

As the pigment, carbon black (“Printex (registered trademark) 80” manufactured by Orion Engineered Carbons S.A.) was used. As the pigment dispersion resin, a styrene-acrylic resin having a molecular weight of 20,000 and an acid value of 100 mg KOH/g (monomer composition: MAA/MMA/BA/St) was used. Sodium hydroxide was blended as a neutralizer for neutralizing the pigment dispersion resin. OLFINE (registered trademark) E1010 is a surfactant blended as a dispersant and is a nonionic surfactant manufactured by Nissin Chemical Co., Ltd. As water, ion exchanged water was used.

The pigment dispersion liquid was prepared by mixing the above components by wet dispersion using a media-type wet disperser. Examples of the media-type wet disperser include a wet disperser (more specifically, “Nano Grain Mill” manufactured by ASADA IRON WORKS. CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using a media-type wet disperser, media (zirconia beads having a diameter of 0.5 mm) were set in a vessel, and the ejection rate was controlled to be 200 to 600 g/min such that the average particle diameter of the pigment dispersion in which the dispersant had adhered to the pigment dispersed in water was 70 to 130 nm. For measurement of the particle size distributions of the pigment dispersion, a diluted solution obtained by diluting the pigment dispersion liquid 300 times with ion exchanged water was measured using “Zetasizer Nano” manufactured by Sysmex Corporation.

Next, inks according to Examples and Comparative Examples were prepared. The inks according to Examples and Comparative Examples were prepared such that the contents of the pigment dispersion (solid content), triethylene glycol monobutyl ether (BTG), 3-methyl-1,5-pentanediol (MPD), glycerin, KL-870, and water would be as shown in Table 2. KL-870 is a surfactant and is a nonionic surfactant manufactured by Nissin Chemical Co., Ltd. As water, ion exchanged water was used.

TABLE 2

| Ink | Content (mass %) |
|---|---|
| Pigment dispersion | 8 |
| BTG | 15 |
| MPD | 25 |
| Glycerin | 5 |
| KL870 | 0 |
| Water | Remainder |

In the preparation of each ink, the solvent was stirred using a stirrer while the components shown in Table 2 were added thereto in the order. Further, the ink obtained after stirring was filtrated using a filter with a pore size of φ5 μm to remove foreign substances, debris, and coarse particles.

### (Evaluation of Pre-Treatment Liquid)

For the pre-treatment liquids according to Examples and Comparative Examples, the bleed-through density and the line width were evaluated using the above common ink. In the evaluation of bleed-through density, the performance of each pre-treatment liquid in suppressing the bleed-through of ink can be determined. Further, in the evaluation of a line width, the performance of each pre-treatment liquid in suppressing the occurrence of gaps in the image can be determined. The evaluation of bleed-through density and the evaluation of a line width were performed under an environment with a temperature of 32 °C and a relative humidity of 15% RH. In the evaluation of bleed-through density and the evaluation of a line width, an inkjet recording apparatus (an inkjet recording apparatus including a line type recording head, a tester manufactured by KYOCERA Document Solutions Inc.) was used.

### Method of Evaluating Bleed-Through Density

In the evaluation of bleed-through density, first, the pre-treatment liquid was applied onto a recording medium (plain paper “Utrillo” (64 gsm) manufactured by Daio Paper Corporation) and then, the ink was ejected to form a solid image having a rectangular shape of 2.3 cm×11.5 cm. After preserving the plain paper on which the image has been formed in a normal temperature and normal humidity environment for one day and one night, the image densities at five points on the back surface in the solid image on the recording medium were measured using a spectrodensitometer (FD-5, manufactured by Konica Minolta, Inc.), and the average value of the image densities at the five points was used as bleed-through density. The measurement conditions were the observation light source D50, the illumination condition M2, the field of view of 2°, and the density status I. The amount of ink to be ejected from one recording head was adjusted such that the surface density in the solid image on the recording medium would be 1.1 to 1.3. For the bleed-through density, evaluation was performed in accordance with the following criteria A to C. Pre-treatment liquids with the evaluation of A or B for the bleed-through density are evaluated to “Pass,” and pre-treatment liquids with the evaluation of C are evaluated to “Fail.”
A: 0.18 or less
B: more than 0.18 and 0.19 or less
C: more than 0.19.

### Method of Evaluating Line Width

In the evaluation of a line width, first, the pre-treatment liquid was applied onto a recording medium (plain paper “Utrillo” (64 gsm) manufactured by Daio Paper Corporation) and then, the ink was ejected to form a 1-dot line (a single line formed by connecting dots). After preserving the plain paper on which the image has been formed in a normal temperature and normal humidity environment for one day and one night, an enlarged image was taken using a microscope (a measurement microscope, manufactured by Nikon Corporation) and the line width of a 1-dot line was measured. The amount of ink to be ejected from one recording head was adjusted such that the density of the 1-dot line on the recording medium would be 1.1 to 1.3. For the line width, evaluation was performed in accordance with the following criteria A to C. Pre-treatment liquids with the evaluation of A or B for the line width are evaluated to “Pass,” and pre-treatment liquids with the evaluation of C are evaluated to “Fail.”
A: 90 μm or more
B: 80 μm or more and less than 90 μm
C: less than 80 μm

### Examples 1 to 8

Pre-treatment liquids according to Examples 1 to 8 were prepared such that the contents of calcium acetate, urea, 1,3-propanediol (1,3PD), KL-870, and water would be as shown in Table 3. 1,3-propanediol (1,3PD) was blended as the first water-soluble organic solvent, and KL-870 was blended as the first surfactant. Further, Table 3 also shows the total content of urea and 1,3-propanediol (1,3PD) for the pre-treatment liquids according to Examples 1 to 8.

TABLE 3

| | | Example | | | | | | | |
|---|---|---|---|---|---|---|---|---|---|
| Pre-treatment liquid | | 1 | 2 | 3 | 4 | 5 | 6 | 7 | 8 |
| Component | Calcium acetate | 6 | 6 | 8 | 8 | 12 | 12 | 8 | 8 |
| (mass %) | Urea | 20 | 30 | 20 | 30 | 20 | 30 | 20 | 25 |
| | 1,3PD | 20 | 20 | 20 | 20 | 20 | 20 | 30 | 25 |
| | KL870 | 0.05 | 0.05 | 0.05 | 0.05 | 0.05 | 0.05 | 0.05 | 0.05 |
| | Ion exchanged | Remain- | Remain- | Remain- | Remain- | Remain- | Remain- | Remain- | Remain- |
| | water | der | der | der | der | der | der | der | der |

| | | | | | | | | |
|---|---|---|---|---|---|---|---|---|
| Total content (mass %) | 40 | 50 | 40 | 50 | 40 | 50 | 50 | 50 |
| of urea and 1,3PD | | | | | | | | |

Table 4 shows the evaluation results of bleed-through density and a line width for the pre-treatment liquids according to Examples 1 to 8. In all of the pre-treatment liquids according to Examples 1 to 8, both the bleed-through density and the line width were evaluated to “Pass.” Focusing on Examples 1 to 6, a tendency was observed where the higher the content of calcium acetate in the pre-treatment liquid, the lower the bleed-through density. Further, comparing Examples 1 and 3 with Examples 2 and 4, a tendency was observed where the higher the content of urea in the pre-treatment liquid, the larger the line width.

TABLE 4

| | | | | Line width | |
|---|---|---|---|---|---|
| | | Bleed-through density | | Evaluation | |
| | | Evaluation | | value | |
| | | value | Evaluation | (μm) | Evaluation |
| Example | 1 | 0.182 | B | 87.77 | B |
| | 2 | 0.186 | B | 92.84 | A |
| | 3 | 0.174 | A | 82.73 | B |
| | 4 | 0.180 | A | 90.12 | A |
| | 5 | 0.168 | A | 80.13 | B |
| | 6 | 0.173 | A | 84.93 | B |
| | 7 | 0.178 | A | 84.54 | B |
| | 8 | 0.180 | A | 88.91 | B |

### Comparative Examples 1 to 5

Pre-treatment liquids according to Comparative Examples 1 to 5 were prepared such that the contents of calcium acetate, glycerin, sorbitol, 1,3-propanediol (1,3PD), KL-870, and water would be as shown in Table 5. 1,3-propanediol (1,3PD) was blended as the first water-soluble organic solvent, and KL-870 was blended as the first surfactant. The pre-treatment liquid according to Comparative Example 1 is different from the pre-treatment liquid according to the above Example in that no moisturizing agent is included. The pre-treatment liquids according to Comparative Examples 2 and 3 are different from the pre-treatment liquid according to the above Example in that glycerin is used as the moisturizing agent instead of urea. The pre-treatment liquids according to Comparative Examples 4 and 5 are different from the pre-treatment liquid according to the above Example in that sorbitol is used as the moisturizing agent instead of urea.

TABLE 5

| | | Comparative Example | | | | |
|---|---|---|---|---|---|---|
| Pre-treatment liquid | | 1 | 2 | 3 | 4 | 5 |
| Component | Calcium acetate | 8 | 8 | 8 | 8 | 8 |
| (mass %) | Urea | | | | | |
| | Glycerin | | 20 | 30 | | |
| | Sorbitol | | | | 20 | 30 |
| | 1,3PD | 20 | 20 | 20 | 20 | 20 |
| | KL870 | 0.05 | 0.05 | 0.05 | 0.05 | 0.05 |
| | Ion exchanged water | Remainder | Remainder | Remainder | Remainder | Remainder |

Table 6 shows the evaluation results of bleed-through density and a line width for the pre-treatment liquids according to Comparative Examples 1 to 5. In all of the pre-treatment liquids according to Comparative Examples 1 to 5 in which no urea was included as a moisturizing agent, the line width was evaluated to “Fail.”

TABLE 6

| | | | | Line width | |
|---|---|---|---|---|---|
| | | Bleed-through density | | Evaluation | |
| | | Evaluation | | value | |
| | | value | Evaluation | (μm) | Evaluation |
| Comparative | 1 | 0.160 | A | 60.45 | C |
| Example | 2 | 0.168 | A | 71.65 | C |
| | 3 | 0.168 | A | 79.63 | C |
| | 4 | 0.160 | A | 66.13 | C |
| | 5 | 0.166 | A | 68.2 | C |

### Comparative Examples 6 to 10

Pre-treatment liquid according to Comparative Examples 6 to 10 were prepared such that the contents of calcium acetate, urea, 1,3-propanediol (1,3PD), KL-870, and water would be as shown in Table 7. 1,3-propanediol (1,3PD) was blended as the first water-soluble organic solvent, and KL-870 was blended as the first surfactant. The pre-treatment liquid according to Comparative Example 6 is different from the pre-treatment liquid according to the above Example in that the content of urea is less than 20 mass %. The pre-treatment liquid according to Comparative Example 7 is different from the pre-treatment liquid according to the above Example in that the content of urea exceeds 30 mass % and the content of the first water-soluble organic solvent is less than 20 mass %. The pre-treatment liquid according to Comparative Example 8 is different from the pre-treatment liquid according to the above Example in that the total content of urea and the first water-soluble organic solvent exceeds 50 mass %. The pre-treatment liquid according to Comparative Example 9 is different from the pre-treatment liquid according to the above Example in that the content of calcium acetate is less than 6 mass %. The pre-treatment liquid according to Comparative Example 10 is different from the pre-treatment liquid according to the above Example in that the content of calcium acetate exceeds 12 mass %.

TABLE 7

| | | Comparative Example | | | | |
|---|---|---|---|---|---|---|
| Pre-treatment liquid | | 6 | 7 | 8 | 9 | 10 |
| Component | Calcium acetate | 8 | 8 | 8 | 4 | 14 |
| (mass %) | Urea | 15 | 35 | 30 | 20 | 20 |
| | 1,3PD | 20 | 10 | 30 | 20 | 20 |
| | KL870 | 0.05 | 0.05 | 0.05 | 0.05 | 0.05 |
| | Ion exchanged | Remainder | Remainder | Remainder | Remainder | Remainder |
| | water | | | | | |

| | | | | | |
|---|---|---|---|---|---|
| Total content (mass %) | 35 | 45 | 60 | 40 | 40 |
| of urea and 1,3PD | | | | | |

Table 8 shows the evaluation results of bleed-through density and a line width for the pre-treatment liquid according to Comparative Examples 6 to 10. In the pre-treatment liquid according to Comparative Example 6 in which the content of urea was low, the line width was evaluated to “Fail.” In the pre-treatment liquid according to Comparative Example 7 in which the content of urea exceeded 30 mass % and the content of the first water-soluble organic solvent was less than 20 mass %, the bleed-through density was evaluated to “Fail.” In the pre-treatment liquid according to Comparative Example 8 in which the total content of urea and the first water-soluble organic solvent exceeded 50 mass %, the bleed-through density was evaluated to “Fail.” In the pre-treatment liquid according to Comparative Example 9 in which the content of calcium acetate was less than 6 mass %, the bleed-through density was evaluated to “Fail.” In the pre-treatment liquid according to Comparative Example 10 in which the content of calcium acetate exceeded 12 mass %, the line width was evaluated to “Fail.”

TABLE 8

| | | | | Line width | |
|---|---|---|---|---|---|
| | | Bleed-through density | | Evaluation | |
| | | Evaluation | | value | |
| | | value | Evaluation | (μm) | Evaluation |
| Comparative | 6 | 0.156 | A | 67.23 | C |
| Example | 7 | 0.191 | C | 95.84 | A |
| | 8 | 0.196 | C | 100.1 | A |
| | 9 | 0.205 | C | 89.79 | B |
| | 10 | 0.162 | A | 65.11 | C |

### Comparative Examples 11 to 14

Pre-treatment liquids according to Comparative Examples 11 to 14 were prepared such that the contents of ammonium formate, magnesium acetate, disodium succinate, trisodium citrate, urea, 1,3-propanediol (1,3PD), KL-870, and water would be as shown in Table 9. 1,3-propanediol (1,3PD) was blended as the first water-soluble organic solvent, and KL-870 was blended as the first surfactant. The pre-treatment liquid according to Comparative Example 11 is different from the pre-treatment liquid according to the above Example in that ammonium formate is used as the metal salt instead of calcium acetate. The pre-treatment liquid according to Comparative Example 12 is different from the pre-treatment liquid according to the above Example in that magnesium acetate is used as the metal salt instead of calcium acetate. The pre-treatment liquid according to Comparative Example 13 is different from the pre-treatment liquid according to the above Example in that disodium succinate is used as the metal salt instead of calcium acetate. The pre-treatment liquid according to Comparative Example 14 is different from the pre-treatment liquid according to the above Example in that trisodium citrate is used as the metal salt instead of calcium acetate. Note that it was difficult to blend more than 2 mass % of disodium succinate and trisodium citrate, which had low water-solubility.

TABLE 9

| | | Comparative Example | | | |
|---|---|---|---|---|---|
| Pre-treatment liquid | | 11 | 12 | 13 | 14 |
| Component | Calcium acetate | | | | |
| (mass %) | Ammonium formate | 12 | | | |
| | Magnesium acetate | | 12 | | |
| | Disodium succinate | | | 2 | |
| | Trisodium citrate | | | | 2 |
| | Urea | 20 | 30 | 20 | 30 |
| | 1,3PD | 20 | 20 | 20 | 20 |
| | KL870 | 0.05 | 0.05 | 0.05 | 0.05 |
| | Ion exchanged water | Remainder | Remainder | Remainder | Remainder |

Table 10 shows the evaluation results of bleed-through density and a line width for the pre-treatment liquids according to Comparative Examples 11 to 14. In all of the pre-treatment liquids according to Comparative Examples 11 to 14 in which no calcium acetate was included as a metal salt, the bleed-through density was evaluated to “Fail.”

TABLE 10

| | | | | Line width | |
|---|---|---|---|---|---|
| | | Bleed-through density | | Evaluation | |
| | | Evaluation | | value | |
| | | value | Evaluation | (μm) | Evaluation |
| Comparative | 11 | 0.198 | C | 88.46 | B |
| Example | 12 | 0.196 | C | 89.41 | B |
| | 13 | 0.201 | C | 86.18 | B |
| | 14 | 0.199 | C | 88.79 | B |

It should be understood by those skilled in the art that various modifications, combinations, sub-combinations and alterations may occur depending on design requirements and other factors insofar as they are within the scope of the appended claims or the equivalents thereof.

What is claimed is:

1. A pre-treatment liquid for a recording medium on which an image is recorded with a water-based ink, comprising:
6 mass % or more and 12 mass % or less of calcium acetate;
20 mass % or more and 30 mass % or less of urea;
20 mass % or more of a first water-soluble organic solvent;
a first surfactant; and
water,
a total content of the urea and the first water-soluble organic solvent being 50 mass % or less.

2. The pre-treatment liquid according to claim 1, wherein
the recording medium is formed of a fiber to have a basis weight of 60 gsm or more and 70 gsm or less.

3. The pre-treatment liquid according to claim 1, wherein
the water-based ink includes a pigment, a pigment dispersion resin, a second water-soluble organic solvent, a second surfactant, and water.

4. An ink set, comprising:
the pre-treatment liquid according to claim 1; and
a water-based ink that includes a pigment, a pigment dispersion resin, a second water-soluble organic solvent, a second surfactant, and water.
